(19) United States
(12) Patent Application Publication
(10) Pub. No.: US 2026/0065161 A1
(43) Pub. Date: Mar. 5, 2026

(54) Real-Time Categorized Learning System with Dynamic Category Generation and Adaptive Model Training

(71) Applicant: Ramin Bolouri, Concord, CA (US)

(72) Inventor: Ramin Bolouri, Concord, CA (US)

(21) Appl. No.: 19/313,727

(22) Filed: Aug. 28, 2025

Related U.S. Application Data
(60) Provisional application No. 63/688,218, filed on Aug. 28, 2024.

(51) Int. Cl. G06N 20/00

(52) U.S. Cl. CPC G06N 20/00

(57) ABSTRACT

A real-time categorized learning system automatically organizes incoming data, dynamically generates new categories via clustering when novel patterns are detected, and adaptively trains models using per-category performance feedback. A categorization engine assigns topical labels and, for textual data, optional sentiment/intent labels. Low-confidence items are buffered for dynamic category generation; newly created categories are persisted with descriptors and immediately available for classification. A training module incrementally updates one or more models to incorporate new categories. A performance module tracks category-level metrics, and an adaptive learning module triggers focused retraining, category merges or splits, active learning, or hyperparameter tuning when thresholds are not met. The system operates in streaming or batch modes and is domain-agnostic (e.g., support, healthcare, finance, education, legal), improving accuracy and resilience as data distributions and taxonomies evolve.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX SUBMITTED ON READ-ONLY OPTICAL DISC

Not Applicable.

### BACKGROUND OF THE INVENTION

### Field of the Invention

The invention relates to machine learning systems and data classification. More particularly, it concerns real-time categorization of data with on-the-fly category (class) creation and adaptive model training driven by per-category performance monitoring.

### Description of Related Art

Conventional classifiers rely on fixed, predefined label sets with substantial up-front labeling. In production settings, however, data distributions and taxonomies drift; novel topics or issue types emerge continuously, making static taxonomies brittle and costly to maintain.

Incremental clustering, stream classification, and sentiment/intent analysis exist but are typically siloed and do not unify real-time category creation with performance-aware learning loops.

Prior work addresses pieces of the problem (e.g., dynamic clustering for streams, domain-specific ticket classification, or quality-directed retraining), yet lacks a single system that (i) classifies in real time, (ii) generates new categories automatically when novel patterns arise, (iii) integrates sentiment/intent labels when applicable, and (iv) adapts model parameters and the category set itself based on per-category performance. There remains a need for a unified, cross-domain architecture that continuously evolves both the taxonomy and the learned model as data changes.

### BRIEF SUMMARY OF THE INVENTION

The invention provides a real-time categorized learning system that: (1) classifies incoming data into existing categories; (2) creates new categories on the fly via clustering when items do not fit the current taxonomy; (3) optionally assigns sentiment/intent labels in parallel for textual data; (4) trains and updates one or more machine-learning models using the evolving labeled corpus; (5) monitors performance per category; and (6) triggers targeted retraining, category merges/splits, or data acquisition when category-level metrics fall below thresholds. The system operates in streaming or batch modes and is domain-agnostic (e.g., customer support, healthcare, finance, education, legal).

### BRIEF DESCRIPTION OF THE SEVERAL VIEWS OF THE DRAWING

FIG. 1 is a block diagram of an embodiment of the Real-Time Categorized Learning System 100, showing principal modules and data flows, including a Data Ingestion Module 101, Categorization Engine 102, Dynamic Category Generation Module 103, Sentiment/Intent Analysis Module 104, Model Training Module 105, Performance Analysis Module 106, Adaptive Learning Module 107, a Category Set 120, a Category/Data Repository 122 (with hierarchy 124, descriptors 126, and centroids 128), Model(s) 130, and Performance Data & Metrics 140 (including 142, 144, 146, 148). An optional computing environment 150-190 is shown to illustrate processors, memory, network, and user interfaces.

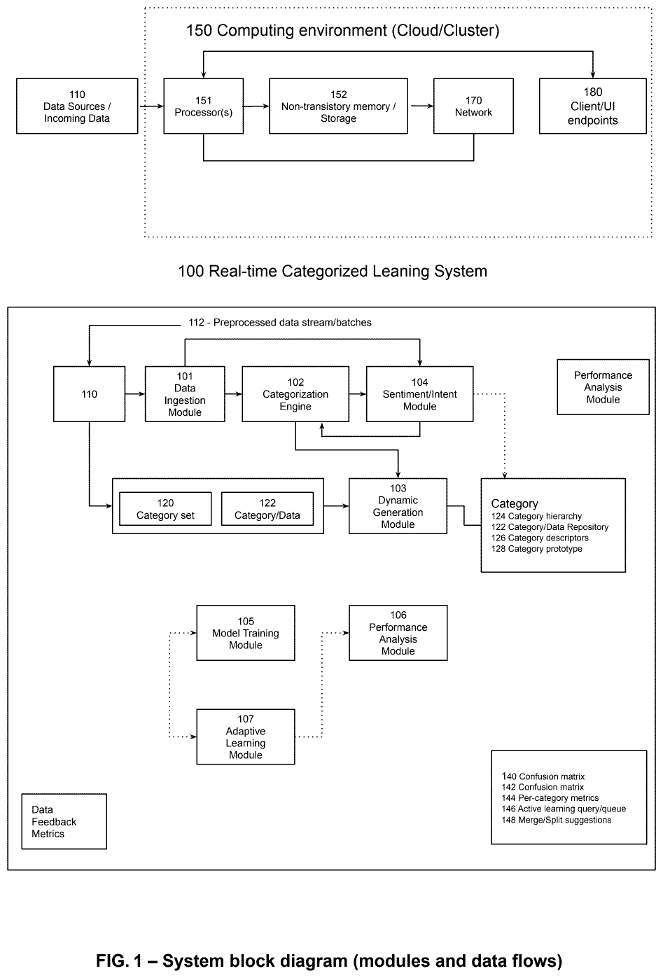

FIG. 2 is a flowchart of a method for dynamic categorization and adaptive learning, depicting representative steps including Ingest & Preprocess 201, Classify into Existing Categories 202, Cluster Novel Items/Create New Category 204, Persist Labels & Update Repository 205, Train/Update Model(s) 206, Compute Per-Category Metrics 208, a Threshold/Drift Decision 210, and Adaptation actions 212 (e.g., retraining, merge/split, and data acquisition).

FIG. 3 is a schematic visualization of feature space 300 illustrating dynamic category generation: existing category clusters 312 and their centroids 316 are contrasted with an emergent cluster 314 and its centroid 318, separated by an illustrative decision/separation boundary 330 used to determine creation of a new category.

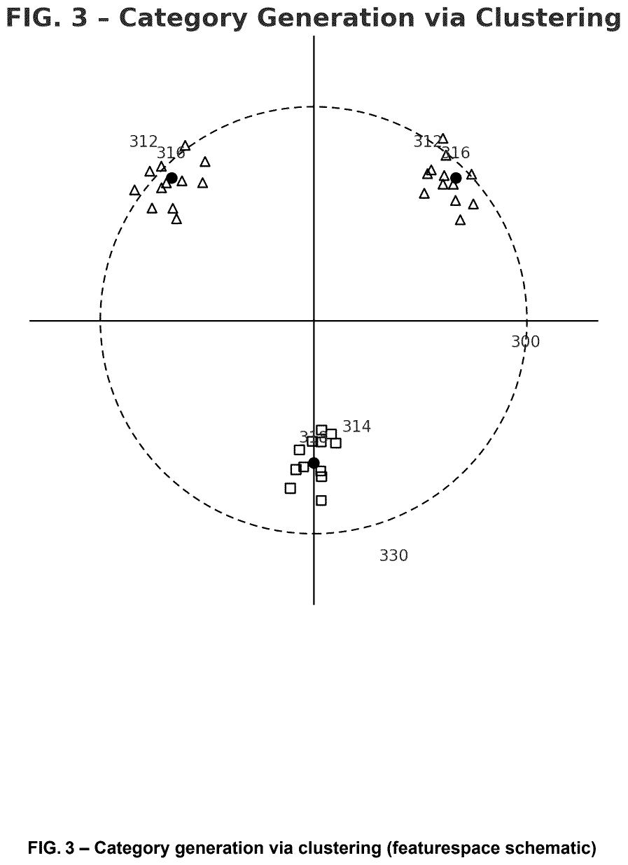

FIG. 4 is a graph 400 of per-category performance over time, plotting representative category traces 410, 412, 418 against time 402 and a metric axis 404 (e.g., F1). A performance threshold 414, an adaptive retrain trigger 420, a post-update improvement indication 430, and a new-category introduction marker 440 are illustrated.

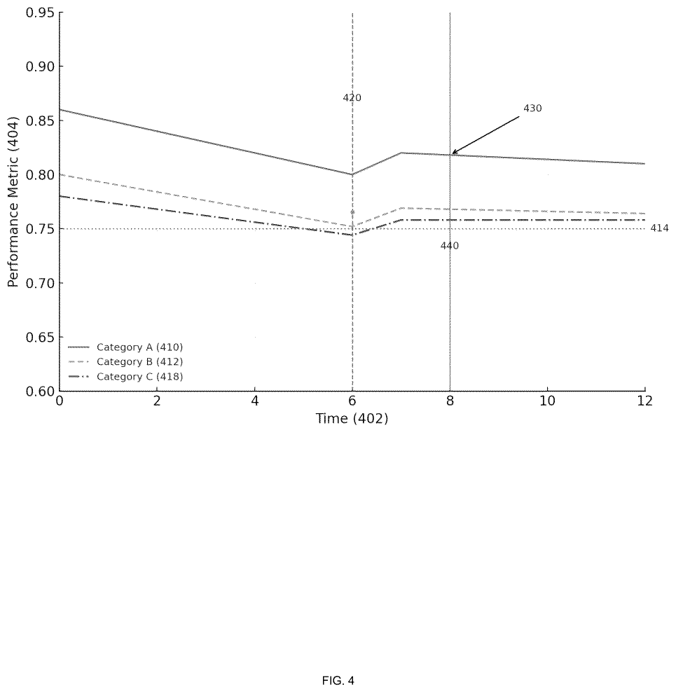

FIG. 5 provides exemplary domain deployments. A customer-support panel 500 shows domain-specific instances of modules 502-507 corresponding to 101-107, with routing/triage 560 and sentiment-based escalation 562. A healthcare panel 550 shows modules 552-557 corresponding to 101-107, with an expert alert 574 and a new medical category record 576 to illustrate cross-domain applicability.

### DETAILED DESCRIPTION OF THE INVENTION

### Overview

In one embodiment, the Categorized Learning System 100 executes in a cloud or distributed environment and comprises: a Data Ingestion Module 101; a Categorization Engine 102; a Dynamic Category Generation Module 103; an optional Sentiment/Intent Analysis Module 104 for textual inputs; a Model Training Module 105; a Performance Analysis Module 106; and an Adaptive Learning Module 107. Components interoperate over a shared Category/Data Repository 122.

### Data Ingestion (101)

Module 101 acquires raw inputs (e.g., support tickets, social posts, sensor streams, transactions) and performs preprocessing such as cleaning, normalization, tokenization, feature extraction, or time-series segmentation, depending on modality. The output is a stream or batch of processed instances suitable for categorization.

### Categorization Engine (102)

Engine 102 assigns each item to one or more existing categories using ML classifiers (e.g., neural networks, decision trees), similarity matching to prototypes/centroids, or rules.

Multi-label assignments are supported. Items with low assignment confidence or high dissimilarity to known categories are flagged as novel and queued to Module 103. Engine 102 accesses the Category Repository 122 for category descriptors (keywords, embeddings, centroids).

### Sentiment/Intent Analysis (104)

For textual inputs, Module 104 determines sentiment polarity (e.g., positive/neutral/negative) and/or intent (e.g., refund request, status inquiry). These labels can be treated as secondary categories and may also enhance topical classification.

### Dynamic Category Generation (103)

Module 103 clusters unclassified/novel items to detect emergent groups. If an emergent cluster is coherent and sufficiently separated from existing categories (e.g., distance above a threshold, or cohesion above a threshold), a new category is created, named using salient tokens or descriptors of the cluster, and stored in Repository 122 with descriptors (e.g., representative centroid, top keywords). For streaming workloads, micro-clusters and time-windowed updates may be used.

### Model Training (105)

Module 105 trains and updates model(s) 130 using the evolving labeled dataset. Modes include initial training, incremental/online updates, periodic retraining, and focused re-training (e.g., weighting examples for underperforming categories or deploying temporary one-vs-rest models for brand-new categories).

### Performance Analysis (106)

Module 106 evaluates per-category metrics (e.g., accuracy, precision/recall, F1 scores; confusion matrices), monitors trends over time, and identifies confusions between categories or emerging degradation (e.g., drift affecting a new or existing category).

### Adaptive Learning (107)

Module 107 triggers interventions based on Module 106 outputs, including: (i) threshold-based retraining; (ii) acquisition of additional data via active learning or targeted sampling for low-resource categories; (iii) category refinement by merge/split; (iv) model/hyperparameter tuning; and (v) staged deployment of specialized sub-models until sufficient data accrues for incorporation into the primary model.

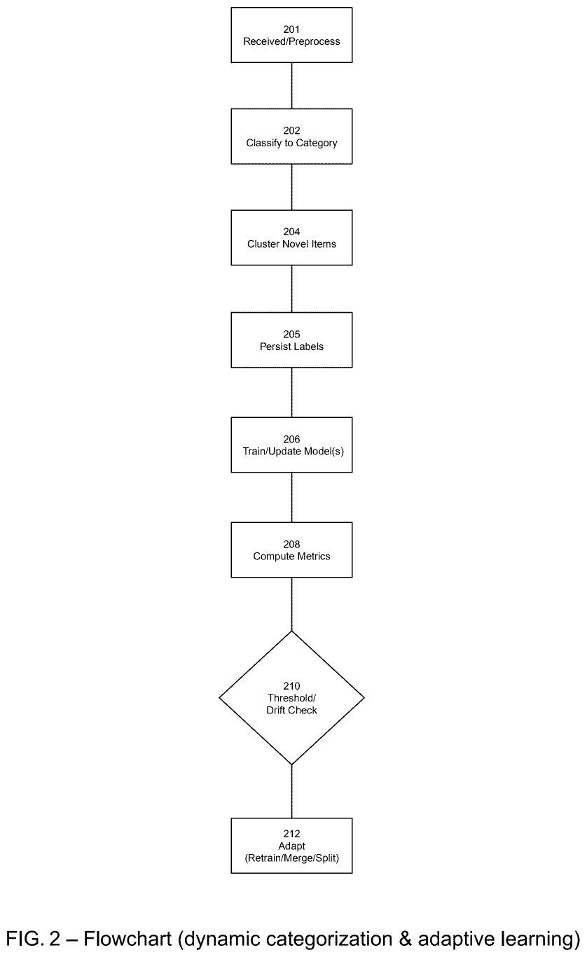

### System Operation (FIG. 2)

Typical operation proceeds as follows: (1) ingest and preprocess data (201); (2) classify into existing categories (202); (3) route low-confidence/novel items to dynamic clustering and form new categories as needed (204); (4) label items and persist to Repository 122 (205); (5) update model(s) (206); (6) compute per-category metrics (208); (7) if metrics fall below thresholds or drift is detected (210), trigger adaptation (212); repeat for streaming or periodic batch contexts.

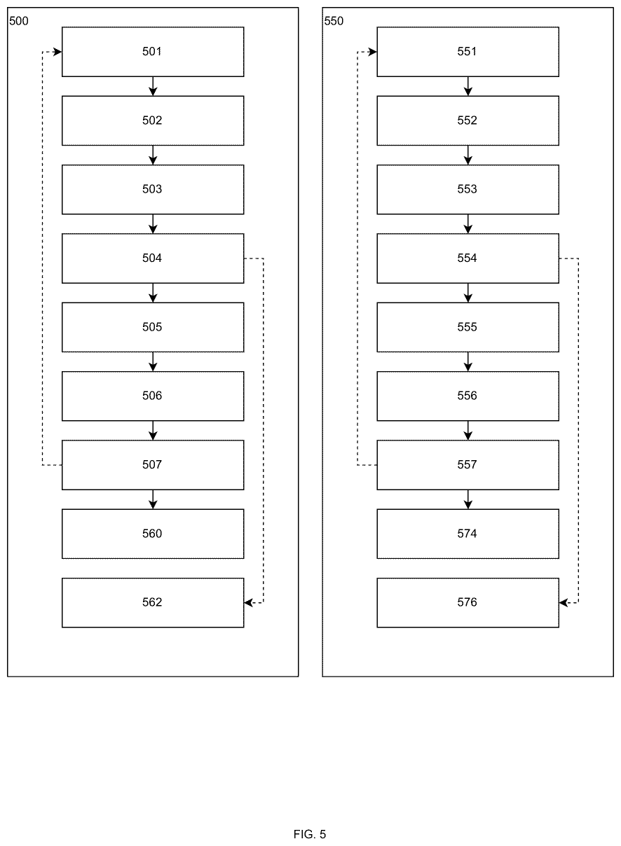

### Example Use Cases (FIG. 5)

Customer Support: The system classifies issue type and sentiment; creates new issue categories when product changes introduce new failure modes; routes/triages accordingly; retrains when category-specific accuracy dips.

Healthcare: The system assigns medical categories (conditions, risk levels), detects clusters of atypical symptom constellations (potential new sub-conditions), and updates diagnostic or triage models while tracking category-level performance. Optional human-in-the-loop confirmation can name/validate novel categories.

### Preferred/Best-Mode Implementation

In a preferred implementation, the system represents textual items with contextual embeddings; Engine 102 performs multi-label classification using a fine-tuned transformer;

Module 103 maintains streaming micro-clusters with radius δ and minimum support m, declaring a new category when (i) centroid separation from all known categories exceeds τ and (ii) silhouette exceeds σ; Module 105 updates models online with mini-batches; Module 106 computes rolling, per-category metrics over a sliding window; Module 107 triggers focused retraining when any category's F1 drops by Δ relative to a moving baseline and initiates active learning to enrich sparse categories.

### Implementation Notes and Variations

The modules may be consolidated, distributed, or replicated; categories may be hierarchical; features may be multi-modal; and operation may be fully automated or include expert checkpoints. Security controls (e.g., anonymization), audit logging, and taxonomy versioning may be provided to satisfy regulatory or enterprise requirements.

1. A categorized learning system, comprising: a data ingestion module configured to receive and preprocess input data comprising a plurality of data items; a categorization engine configured to classify each data item into one or more existing categories; a dynamic category generation module configured to detect uncategorized data patterns by clustering data items that are not adequately classified by the existing categories and to create a new category in response to identifying a cluster of data items with similar features that diverges from all existing categories; a model training module configured to train or update at least one machine-learning model using data items classified into the existing categories and any new category; a performance analysis module configured to evaluate performance of the at least one machine-learning model on a per-category basis using one or more metrics; and an adaptive learning module configured to automatically adjust the system by triggering a retraining of the machine-learning model or a refinement of category definitions when the performance for at least one category falls below a predefined threshold.

2. The system of claim 1, wherein the categorization engine includes or interfaces with a natural-language processing component that extracts linguistic features or embeddings from textual data items for assigning categories.

3. The system of claim 1, wherein the existing categories are organized hierarchically with parent and child categories and the dynamic category generation module is further configured to place a new category as a sub-category under an existing category when an emergent cluster represents a specialization of that existing category.

4. The system of claim 1, wherein the dynamic category generation module uses an unsupervised clustering algorithm selected from k-means, hierarchical clustering, DBSCAN, or Gaussian mixture models and determines to create the new category when a resulting cluster's distance from all existing category centroids exceeds a threshold or its cohesion metric exceeds a threshold.

5. The system of claim 1, wherein the categorization engine is configured to assign multiple category labels to a single data item including at least one primary topical label and at least one secondary attribute label.

6. The system of claim 5, further comprising a sentiment and intent analysis module configured to analyze textual content to determine sentiment polarity or user intent, wherein the categorization engine assigns the sentiment or intent as the secondary label in addition to a primary topical label.

7. The system of claim 1, wherein the model training module performs incremental learning by updating the machine-learning model continuously or periodically as new labeled data items become available.

8. The system of claim 1, wherein the performance analysis module computes category-specific metrics and a confusion matrix, and the adaptive learning module identifies confusion between categories and initiates a category refinement action selected from merging two categories or splitting a broad category into multiple categories.

9. The system of claim 1, wherein upon determining that a newly created category has fewer than a minimum number of training examples or yields low accuracy, the adaptive learning module triggers an active learning process to obtain additional labeled data for that category.

10. The system of claim 1, further comprising a data repository that stores categorized data items and category definitions including descriptors selected from keywords, prototype data points, or learned centroids, wherein newly created categories are populated with descriptor information for future classification.

11. A computer-implemented method for categorized learning, comprising: receiving a set of input data items and preprocessing the items to extract features; classifying each data item into one or more category labels using a current category model or rules; identifying at least one data item not satisfactorily classified under predefined categories; clustering the at least one data item with similar items to detect an emergent group; generating a new category for the emergent group including assigning an identifier and initial description based on common features; assigning the new category label to items in the emergent group and adding the new category to the set of categories for future classification; training a machine-learning model using the labeled items including the new category; evaluating performance of the model with respect to each category by computing one or more evaluation metrics; and adapting the learning process by at least one of retraining or fine-tuning the model, merging or splitting categories, or updating feature extraction or classification rules.

12. The method of claim 11, wherein classifying comprises applying a trained text classifier to textual content to predict a topical category and further comprises assigning a sentiment category in parallel.

13. The method of claim 11, wherein generating the new category includes determining a representative name or description by extracting common keywords or characteristics from the emergent group and storing the description in a category repository.

14. The method of claim 11, wherein training includes incrementally updating an existing model without retraining from scratch to expand the output space to include the new category.

15. The method of claim 11, wherein evaluating includes computing a confusion matrix and detecting frequent misclassification between a first and a second category, and adapting includes adjusting a decision boundary by augmenting training data for those categories or modifying model hyperparameters.

16. The method of claim 11, wherein adapting includes initiating an active learning query to obtain correct labels for unlabeled data similar to a category of interest or to request expert review of that category's definition.

17. The method of claim 11, further comprising continuously repeating the receiving, classifying, identifying, clustering, and generating steps for streaming input data so that categories and the model are iteratively updated as the data evolves.

18. A non-transitory computer-readable medium storing instructions that, when executed by one or more processors, cause performance of the method of claim 11.

19. A computer-implemented method for automated customer support, comprising: receiving customer inquiries with unstructured text; analyzing each inquiry to determine an issue-type category and to extract features indicative of sentiment or urgency; classifying each inquiry into one or more predefined support categories and assigning a sentiment label; detecting a subset of inquiries that do not match predefined categories above a confidence threshold and clustering the subset to identify a previously unrecognized issue type; creating a new support category representing the unrecognized issue type and labeling clustered inquiries accordingly; routing or responding to inquiries based on assigned categories and sentiment; training or updating a support automation model using historical inquiries labeled with issue type and sentiment; evaluating the model's accuracy per category; and, upon accuracy for a category falling below a target, adapting by retraining with additional data or refining the category definition including optionally merging with another category.

20. The method of claim 19, wherein the predefined support categories comprise a set selected from technical issue, account/billing issue, product inquiry, feedback, and other, and the set is updated by adding the new support category.

21. The method of claim 19, wherein sentiment analysis yields a sentiment score and inquiries with negative sentiment combined with a critical issue type are escalated or prioritized.

22. The method of claim 19, wherein the support automation model is a chatbot or virtual assistant and training includes fine-tuning a language-generation model on categorized inquiries to produce context-appropriate answers or suggestions.

23. A computer-implemented method for medical data analysis, comprising: receiving patient-related data instances; categorizing each instance into one or more medical categories including assigning at least one category corresponding to a medical condition or diagnosis; identifying instances that do not clearly fit existing medical categories and clustering those instances; defining a new medical category for a cluster of instances and tagging the instances accordingly; training a medical predictive model using the categorized data with categories as features or targets; evaluating performance per category; and, upon underperformance for a new or existing category, triggering at least one of: collecting additional data, adjusting model parameters, or alerting medical experts to review and refine the category or model.

24. The method of claim 23, wherein medical categories include at least one of disease or condition categories, symptom clusters, risk-level categories, or demographic segments, and further comprising updating medical guidelines or a knowledge base with the new category upon expert validation.

25. The method of claim 23, wherein receiving includes ingesting free-text clinical notes and performing natural-language processing to extract medical entities and context used for category assignment.

26. The method of claim 23, wherein defining the new medical category triggers a workflow that alerts a specialist with details of clustered instances so the specialist can provide a meaningful name or confirmation, and thereafter the confirmed category is used in subsequent classification and model training.
